(19) United States
(12) Patent Application Publication
(10) Pub. No.: US 2010/0199618 A1
(43) Pub. Date: Aug. 12, 2010

(54) Effluent collection and filter apparatus with drainage

(76) Inventor: Ernest L. Tomkiewicz, Grafton, NH (US)

Correspondence Address: Ernest L. Tomkiewicz, 61 Tunnel Rd, Grafton, NH, 03240, US

(21) Appl. No.: 12/378,056

(22) Filed: Feb. 11, 2009

(51) Int. Cl. B01D 35/02; B01D 46/10

(52) U.S. Cl. 55/421

(57) ABSTRACT

An effluent collection and filter apparatus with drainage designed to collect effluent discharged from a cooking exhaust system, separate water from grease and allow only water to escape. The ECFAD is attached at a point below the lowest area where effluent needs to be collected. The apparatus is secured to either the exhaust duct or roof. In the apparatus is an absorbent padding designed to absorb grease and repel water. Below the absorbent is a grate that allows water to flow under the padding. In the corners are water only release fittings to let water out and keep grease in.

### FIELD OF INVENTION

This application claims the benefit of U.S. Provisional Application for Patent. Filed on Mar. 20, 2008.

This invention relates to effluent collection and filtering of cooking oils discharged from exhaust fans and ducts, while being able to release clean safe water.

### BACKGROUND OF INVENTION

Food service establishments produce and discharge grease through a series of ducts and exhaust fans. The grease that is discharged can contaminate the roof causing deterioration of roofing material, leaking of the roof, fire and/or contamination of the ground water as it washes off the roof. If accumulated on the side of a building it can cause a fire and/or health hazard. The following examples are attempts to contain this problem. All are different but none seem to reach the goal of complete containment without problem areas.

U.S. Pat. No. 4,635,617 Called “Grease Catch Basin with Solvent Reservoir for use with Cooking Exhaust System.” This unit is large requiring a lot of space under the fan for installation, which is not always possible. As well the use of solvents in the unit is not environmentally sound as a leak could cause a hazardous situation.

U.S. Pat. No. 4,869,236 Called “Apparatus for Collecting and Storing Grease Discharged from Roof Mounted Exhaust Fan’. This unit has pipes and a storage area which can become clogged very easily as grease congeals especially in cold weather. This would cause a back-up defeating the purpose of the unit. In addition, it is a very large unit requiring a fan to be raised well off the roof surface.

U.S. Pat. No. 5,814,115 Called “Grease Filter for Exhaust System in Commercial Food Preparation Environments”. This device funnels grease with a pipe which can become clogged when grease cools down. It can only be used on a flat surface as on a pitched roof the weight can cause it to fall. Also it does not address grease leaking from seams and other areas.

U.S. Pat. No. 5,814,115 Called “Grease Filter for Exhaust System in Commercial Food Preparation Environments”. This device funnels grease with a pipe which can become clogged when grease cools down. It can only be used on a flat surface as on a pitched roof the weight can cause it to fall. Also it does not address grease leaking from seams and other areas.

U.S. Pat. No. 6,143,047 Called “Effluent Containment Assembly”. This units size makes it undesirable. As grease is absorbed into large pads they get extremely heavy and removing a 50 pound grease laden pad can be dangerous. As well, water building up between the rubber liner and roofing material can cause deterioration of the roof surface.

U.S. Pat. No. 6,468,323 Called “Grease Containment Assembly”. This unit uses absorbent pads laid directly into the bottom of a channel pan. This can cause grease laden pads to adhere to the bottom of the channel, especially in cold weather. As well, this causes effluent and water to combine. The openings directly in the bottom will allow all fluids, water and grease, to leak onto the roof. The mesh screen on top of the absorbent pads, designed to hold them in place, will act as a channel funneling the grease over the unit and onto the roof surface.

With all of the above patents, all are made for up blast fans on a roof, one is made for a utility set fan, and none are made for wall terminations. All have shortcomings keeping grease off the roof surface. Whether through seeping out of edges, backing up, leaking over the device or through unprotected openings

### BRIEF SUMMARY OF THE INVENTION

The following summary will give an over view of the detailed description below. The ECFAD is a system of gutter troughs used to collect grease and sludge released from exhaust fans and ducts. Grease and sludge are deflected into filter absorbent pads for easy removal. The unit is attached to the exhaust duct or fan with hangers that also make the unit serve to make the unit ridged and stable. The trough is attached to the corner pieces with connectors that run inside and outside giving the unit stability and an extra layer of protection against leakage. In the gutter trough a filter screen is placed at an angle, this prevents the filter pads from adhering to the bottom of the trough as well as letting the rain water run-off flow easily underneath. In the corners of the unit are placed a specially designed water release valve (which will be described in more detail later) this valve will allow rain water out and keep grease in.

As you will see from the following drawings and their descriptions this unit has many needed attributes that make it different and superior to previous grease containment devices.

### BRIEF DESCRIPTION OF THE DRAWINGS

FIG. 1: Front view of standard installation on roof fan with exhaust vent.

FIG. 2: Cut-away view along gutter trough including water valve in corner.

FIG. 3: View, from above, of corner of unit.

FIG. 4: View, from above, of FIG. 1. Complete unit, standard installation.

FIG. 5: Exploded view of water valve installed in gutter, from the side.

### DETAILED DESCRIPTION OF DRAWINGS

The descriptions of the invention are the preferred design, but the unit and it's design can be used in other shapes, all with the same structure. i.e. one, two, three or four sides. As well the placement of the device, to collect effluent, can vary, depending on the design of the exhaust it's being used on.

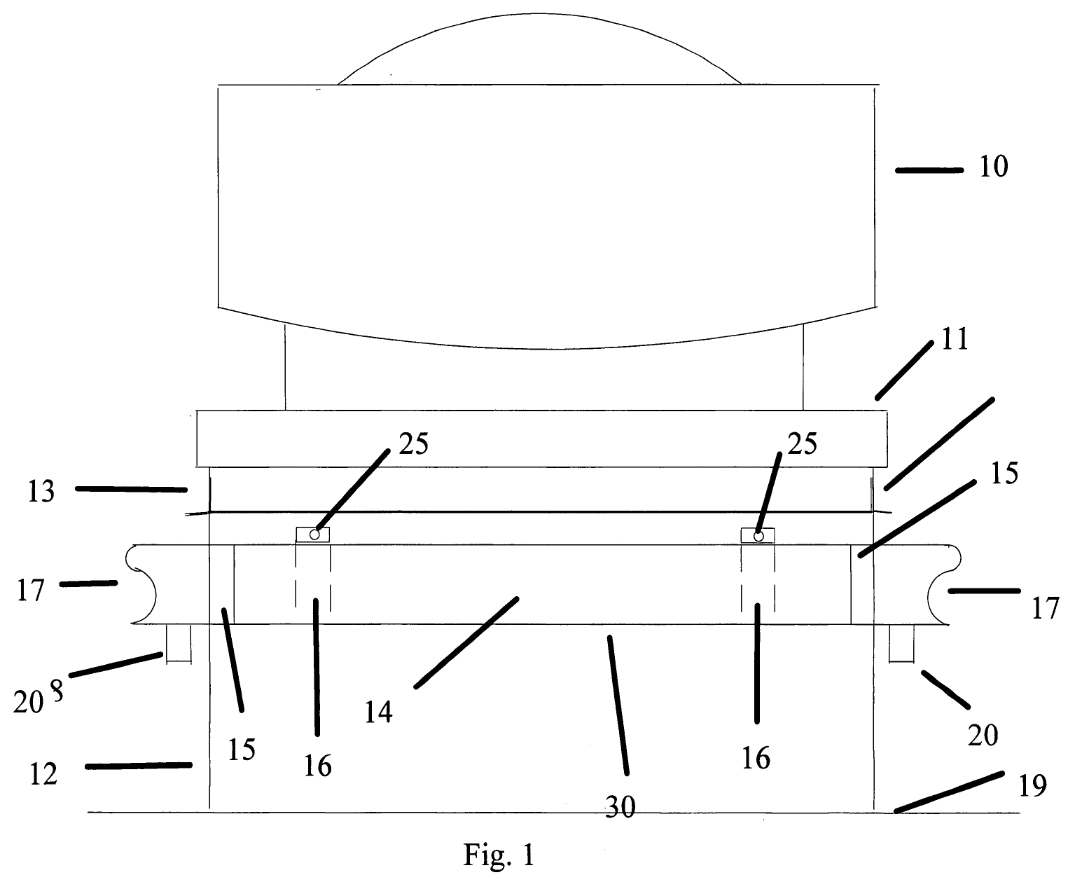

FIG. 1 Shows an Effluent Collection and Filter Apparatus with Drainage 30. The ECFAD 30 is typically attached to an exhaust duct 12 below the exhaust fan 10 base 11. Typically the exhaust duct 12 will extend upward out of the roof surface 19. As exhaust grease is discharged at the fan base 11, it is directed into the gutter troughs 14 via the metal deflector 11. The ECFAD 30 is generally made from a ridged vinyl, plastic or pvc.

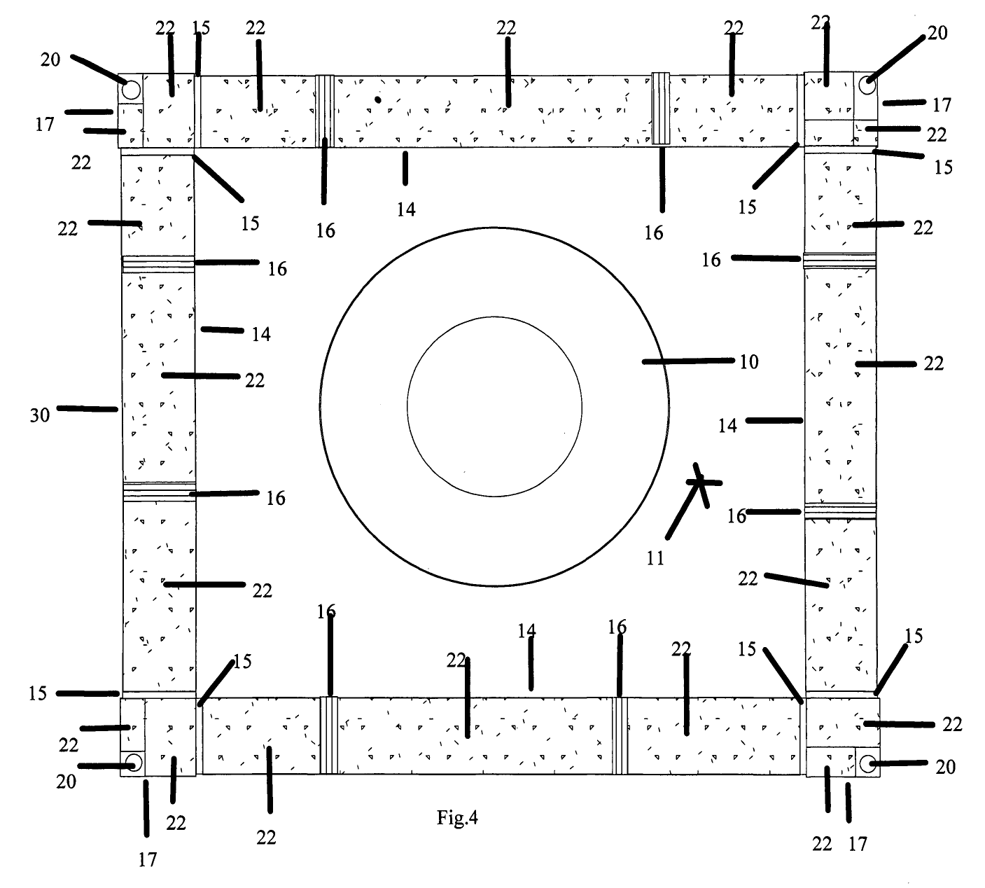

FIGS. 1 and 4 show typical installation of the ECFAD 30. A gutter trough length 14 is attached at each end to a corner piece 17 using a gutter clamp 15. One part of the gutter clamp 15 is slid into a channel on the interior of the gutter length 14 and corner piece 17. The outer piece of the gutter clamp 15 wraps around the exterior of the gutter length 14 and corner piece 17, it is locked into place over the out side of the gutter length 14 channel. This is done with four gutter lengths 14 and four corner pieces 17 with the result a square as in FIG. 4. Each gutter length 14 has two gutter hangers 16 that slide into the gutter length 14 channel. The gutter hangers 16 are used to give the ECFAD 30 extra strength as well as to mount the unit. The ECFAD is typically mounted 4-5 inches below the fan base 11. 1 inch above the ECFAD 30 an “L” shaped length of metal is installed on the duct 12, around it's perimeter. This will deflect grease into the filter pads 22. The deflector 13 is attached with screws 23.

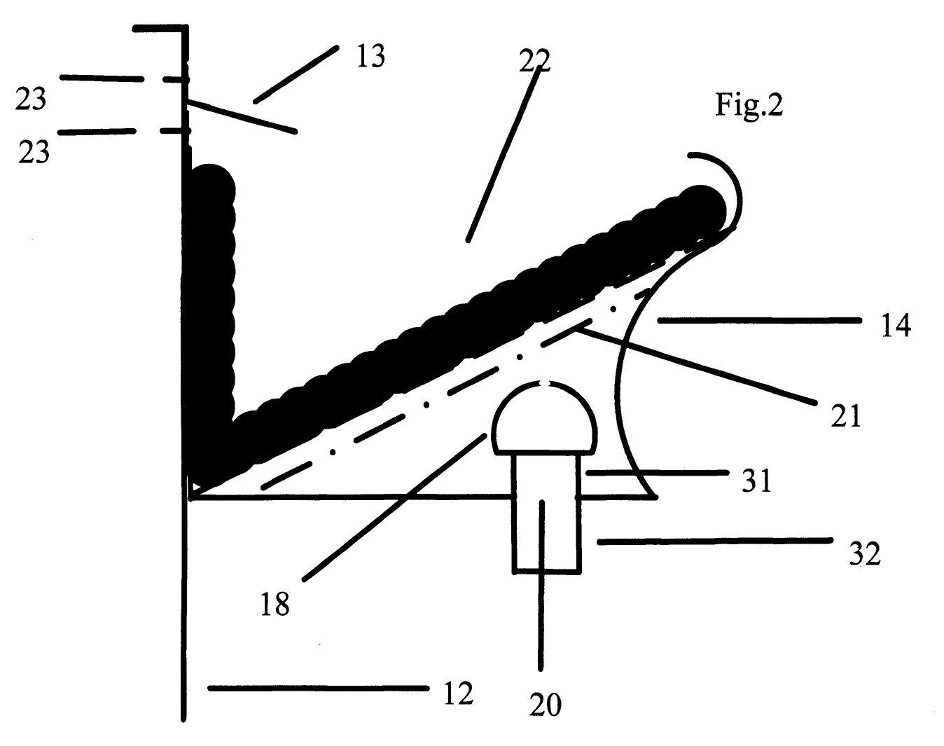

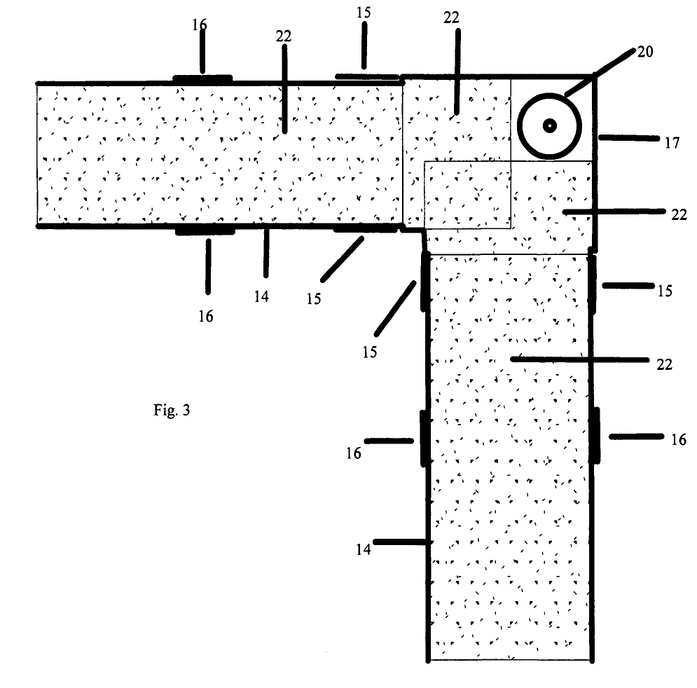

The ECFAD 30 is mounted to the duct 12 with one screw 25 through each gutter hanger 16. Now referring to FIGS. 2 and 3. Into each gutter length is placed a 5 inch wide mesh grate 21 along the entire length of each gutter length 14. This mesh screen 21 is placed at an angle, starting at the bottom of the back edge of the gutter length 14 and landing at the top of the gutter length 14 outer upper channel. On top of the mesh screen 21 is placed an oil only absorbent pad 22. The pad 22 starts at the upper inner front edge of the gutter length 14 and runs over the entire mesh screen 21 and up the back inside edge of the gutter length 14. The front and back edges of the filter pad 22 hook under the Front and rear channel in the gutter length 14, the same channel that the gutter Hangers 16 and gutter clamps 15 slide into. Hangers 16 and gutter clamps 15 slide into.

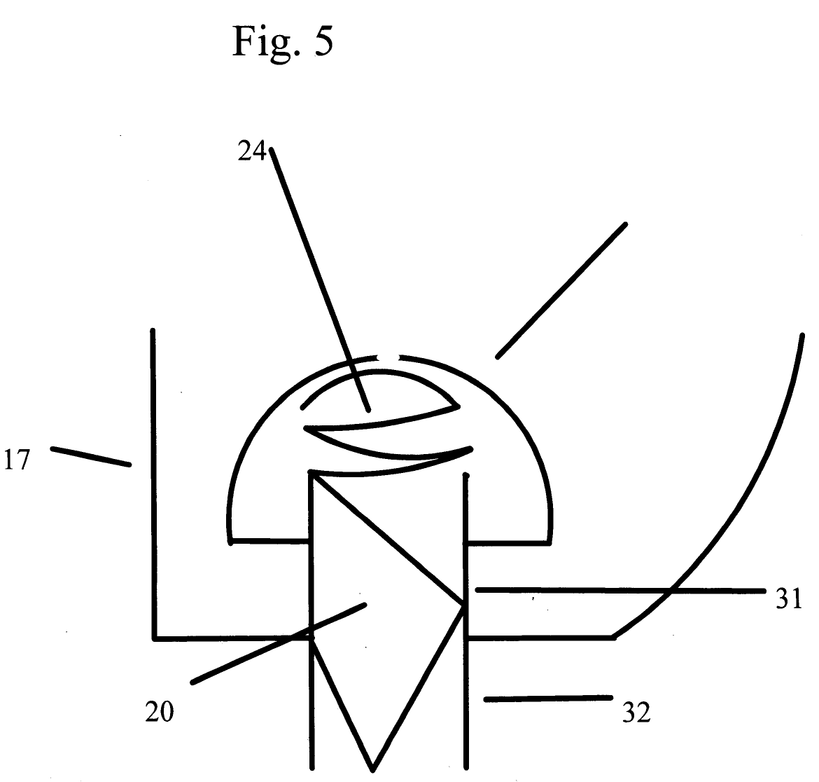

FIG. 2 and 5 show the proper placement of the water only release valve 20. In the center of each corner piece 17 is a round hole approximately one inch in diameter. The water only release valve 20 is comprised of four pieces. A hollow cylinder with one end male threaded is the upper valve tube 31. The lower valve tube 32 is similar to the upper valve tube 31 except it is female threaded on one end. A hollow dome shaped piece with a small hole in the top, to allow air flow, is the valve hood 18. And the valve wire 24 is a rigid piece of wire, the bottom of the wire is “V” shaped it forms upward into a spiral. The upper valve tube 31 is placed into the hole in the corner piece 17 with the threaded end extending downward and out the bottom. The lower valve tube has the female end threaded onto the upper valve tube 31 from the outside of the bottom of the corner piece 17. Into the top of the upper valve tube 31 is placed the valve wire 24. The “V” shaped end points down to hold it in place in the upper valve tube 31. On top of the valve wire 24 is placed the valve hood 18. It is held in place with a small bit of silicone sealant placed on the top coil of the valve wire 24. The valve hood 18 extends down around the upper valve tube 31. It does not touch to the bottom of the corner piece 17, it ends approximately one inch above the bottom of the corner piece 17.

### References Cited

U.S. Patent Documents

| | | |
|---|---|---|
| 4,635,617 | January 1987 | Simonsen |
| 4,869,236 | September 1989 | Blough |
| 5,196,040 | March 1993 | Malloy et al. |
| 5,814,115 | September 1998 | Allen et al. |
| 6,010,558 | January 2000 | Ackland |
| 6,143,047 | November 2000 | Jodoin et al. |
| 6,468,323 | July 2001 | Chwala |

1. An Effluent collection and Filter Apparatus With Drainage to collect grease and effluent. Placed around the perimeter of an up blast fan, that has a duct extending from a roof. Or placed under the lowest edge of an up blast fan with a duct extending from a wall. Or placed under the lowest point of a utility set fan with either a roof or wall termination point. The apparatus is a “U”-shaped trough, that connects with clamps and gaskets so as not to allow any fluid to escape until it has been separated. Installed in the trough is a grated type material that allows water to flow underneath it, in the trough. On top of the grate is an oil only absorbent pad that accepts grease and repels water to the channel below. At the ends, or corners, is a small pipe which is one inch higher than the lowest point in the trough and extends through the bottom of the trough. A coiled wire is placed in the pipe. On top of the wire is placed a hood. The hood extends down around the small pipe but not to the base of the trough. Any effluent floating on the water cannot escape. As the water rises and flows out the pipe the effluent will be higher than the release point and remain in the apparatus.

2. The ECFAD as claimed in 1, has two small channels along the top. Both run parallel, one along the front edge and one along the back edge. Both on the interior of the trough. The channels have two purposes:
A. To allow the support rods to slide and interlock, giving the trough strength.
B. The absorbent pads slide into the channels thus holding them in place without the use of clips or clamps.

3. The ECFAD as claimed in 2, support rods also have a hole at the top to allow a screw to attach the apparatus to the fan, duct or wall, thus holding it in place.

4. The ECFAD as claimed in 1, has a mesh grate liner that is placed under the absorbent pad to prevent the pad from adhering to the bottom of the trough and to allow water to flow to the release pipe valve.

5. The ECFAD as claimed in 1, has a metal guard placed above the apparatus to direct effluent into the absorbent pad.

6. The ECFAD as claimed in 1, has 4 90 degree corner pieces. To each corner piece a straight section is attached, forming a square.

7. The ECFAD as claimed in 6, each corner piece and straight section when placed together are secured with a two piece clamp. One part attaches to the interior of the apparatus by sliding into the channels (of claim 2). The other clamp piece has two large channels that hook onto the exterior of the apparatus and wrap around it securing the two clamp pieces to the apparatus.

8. The ECFAD as claimed in 7, the clamps are sealed with an attached rubber gasket on the interior of the apparatus and applied liquid sealant on the outside. Thus preventing the escape of effluent.

9. The ECFAD as claimed in 1, has one hole in each corner at the bottom of the trough, each hole is approximately one inch in diameter. Into the holes are placed a plastic hollow cylinder shaped piece. The piece has male threads. From the outside of the unit a similar piece, with female threads, is tuned on to it securing the two pieces together and to the bottom of the trough. Into the top of the cylinder piece is placed a ridged piece of wire. The bottom of the wire has a “V” shape to hold it in place in the cylinder. The wire goes straight up to form a coil like a spring shape. On top of the wire is placed a hood shaped like a hollow dome. The sides of the hood extend down around the cylinder to a point approximately 1 inch above the base of the trough. This allows the water to drain while effluent remains in the trough.

10. The ECFAD as in claim 9, The hood piece is held in place with silicon sealant applied to the top of the metal wire.

11. The ECFAD as in claim 9, the hood piece has a small hole, approximately ⅛th-¼th of an inch, in the exact center of the top. To allow for air flow.

12. The ECFAD as in claim 2, The support rods slide into the front and rear channel of each trough. Thus giving the apparatus extra support to prevent collapse.
